(19) United States
(12) Patent Application Publication
(10) Pub. No.: US 2008/0179256 A1
(43) Pub. Date: Jul. 31, 2008

(54) System and method for chemical-free metal particle removal from a liquid media

(75) Inventors: Brian E. Butters, London (CA); Anthony L. Powell, London (CA)

Correspondence Address: BAKER & MCKENZIE LLP;PATENT DEPARTMENT, 2001 ROSS AVENUE, SUITE 2300, DALLAS, TX, 75201, US

(73) Assignee: PURIFICS ENVIRONMENTAL TECHNOLOGIES, INC., London (CA)

(21) Appl. No.: 12/018,470

(22) Filed: Jan. 23, 2008

Related U.S. Application Data
(60) Provisional application No. 60/886,232, filed on Jan. 23, 2007.

(51) Int. Cl. C02F 1/64; C02F 1/58; B01D 24/00

(52) U.S. Cl. 210/722; 210/721; 210/266

(57) ABSTRACT

Disclosed are systems and methods for removing oxidizable metals from a liquid without the use of chemicals. This aeration technology maximizes the surface area-to-volume ratio of oxygen in the gas used. A system may comprise a dissolved oxygen addition device configured to receive the liquid and comprising a substrate with pores. A compressed gas source is connected to the device and configured to inject compressed gas containing oxygen through the substrate and into the liquid. Sub-micron sized bubbles are created on the substrate when the gas passes through the pores and expands in the liquid. The bubbles are removed from the substrate by passing liquid media while they have buoyancy insufficient to overcome a surface tension between the substrate and the bubbles. The bubbles then diffuse into the liquid to oxidize soluble oxidizable metals in the liquid media to create oxidized insoluble metal particles.

### CROSS-REFERENCE TO RELATED APPLICATIONS

This application claims the benefit of U.S. Provisional Patent Application Ser. No. 60/886,232, filed on Jan. 23, 2007, and entitled “SYSTEM AND METHOD FOR CHEMICAL-FREE IRON REMOVAL WITHOUT AIR STRIPPING,” which is commonly assigned with the present application and incorporated herein by reference for all purposes.

### TECHNICAL FIELD

The present disclosure relates generally to purification systems and methods, and more particularly to chemical-free systems and methods for removing oxidizable metal particles, such as iron or manganese, from a liquid media.

### BACKGROUND

Since almost all forms of life need water to survive, the improvement of water quality in decontamination systems has typically been a subject of significant interest. As a result, treatment systems and techniques for removing contaminants from contaminated fluids have been developed in the past. Prior approaches have included water treatment by applying various microorganisms, enzymes and nutrients for the microorganisms in water. Other approaches involve placing chemicals in the contaminated fluids, such as chlorine, in an effort to decontaminate supplies. Some such systems have proved to be somewhat successful; however, sever deficiencies in each approach may still be prominent.

In some prior systems, solid reactants are used that have to be dissolved or dispersed prior to use, or were cumbersome and not particularly suited for prolonged water treatment, or could not be used in a wide variety of different types of applications. In particular, the handling of the solid reactants often posed problems with respect to different dissolution rates, concentrations and growth rates. In addition, in systems employing chemical additives, the resulting “decontaminated” fluid may actually now be contaminated by these chemicals, in spite of having removed the original biological or other contaminants from the media. Even in systems employing microfiltration, problems with the system may not be from any sort of additive, but instead may simply be the clogging of the filter elements or membranes with foulants accumulated from the decontamination process. Time-consuming filter cleaning processes combined with system downtime can become costly and inefficient for purification companies. Some more advanced treatment systems and techniques include treatments using a photolytic or a photocatalytic process. Common photocatalytic treatment methods typically make use of a technique by which a photocatalyst is bonded to contaminants in order to destroy such biomaterials.

However, no matter the approach to decontamination employed, in the treatment of volatile organic compounds (VOCS) and semi-volatile organic compounds (SVOCs) in wastewaters and other media, it is common for these types of waters (or other media) to contain dissolved iron (i.e., Ferrous iron). In some applications, it is required and/or advantageous to remove the iron as a pretreatment, depending upon the nature of the application and the VOC treatment technology. The same holds true for other dissolved metals, such as manganese.

For the removal of iron, air or oxygen can be used to oxidize ferrous iron particles into insoluble ferric iron. With such approaches, once the iron particles have been converted to insoluble particles, the iron can be removed via simple filtration. This is common practice in the decontamination industry. Moreover, such an approach is a desirable method of removing the iron because no aggressive chemicals are required. All that is left is ferric or iron oxide (Fe₂O₃) to dispose of using filtration. In many applications, the iron oxide can be discharged to the public sanitary sewer system, eliminating off-site disposal and thereby reducing overall system costs.

Despite the advantages associated with such an approach, these methods of iron removal are problematic in applications in which the wastewater contains VOCs or various SVOCs. More specifically, the problems occur due to the problem of stripping the VOCs out of the wastewater. Basically, all of the wastewaters containing dissolved iron are in a reduced form and consequently have little to no dissolved oxygen, for example, groundwater. Consequently, standard methods that aerate the wastewater utilize very large amounts of air or oxygen volumes in order to saturate the water with dissolved oxygen, which is required for full iron oxidation. However, aerating the wastewater to provide the large amounts of air or oxygen can introduce significant costs into the overall system, as well as introducing additional equipment subject to breakdown and maintenance. Accordingly, what is need is a system and method for removing iron from contaminated media, without the use of chemicals and that does not suffer from the deficiencies found in conventional approaches.

### SUMMARY

Disclosed herein are systems and methods for efficiently removing iron without air stripping and without the use of chemicals. This is accomplished with a novel aeration technology that maximizes the surface area-to-volume ratio of the air or oxygen gas used in the system. This maximizes the contact between the gas and water, while minimizing the volume of gas. In addition, the disclosed technique greatly enhances the mass transfer of the air/oxygen gas bubbles to the water by employing high mixing (i.e., a high Reynolds numbers). The net effect is that the wastewater will become saturated with dissolved oxygen with significantly less volumes of gas having to be employed. This in turn, results in forming large insoluble metal oxide particles without air stripping VOCs and SVOCs during the process. The large insoluble particles may then be filtered by even crude filtration techniques.

In one embodiment, a system for the chemical-free removal of oxidizable metals from a liquid media is disclosed. Such a system may comprise a dissolved oxygen addition device comprising a substrate having pores therethrough between a dry side and a wet side, where the substrate is configured to receive passing liquid media along its wet side. The system may also include a compressed gas source connected to the dissolved oxygen addition device and configured to inject compressed gas through the substrate to the liquid media. In such embodiments, the compressed gas comprises oxygen and has a pressure greater than a pressure of the liquid media. Further, the system may include sub-micron sized bubbles created on the wet side of the substrate when the compressed gas passes through the pores and expands in the liquid media. In such embodiments, the bubbles are removable from the wet side by the passing liquid media while the bubbles have buoyancy insufficient to overcome a surface tension between the substrate and the bubbles. Once removed by the passing liquid media, the bubbles diffuse into the aqueous phases creating dissolved oxygen that is capable of oxidizing soluble oxidizable metal in the liquid media to create oxidized insoluble metal particles.

In another embodiment, a system for chemical-free removal of oxidizable metals from a liquid media is provided. In an exemplary embodiment, the system includes a cross-flow filtration unit configured to receive the liquid media therein, and a ceramic membrane having pores therethrough between a dry side and a wet side. The ceramic membrane is configured to receive passing liquid media along its wet side. In addition, such a system may include a compressed gas source connected to the dissolved oxygen addition device and configured to inject compressed gas through the ceramic membrane to the liquid media. In such embodiments, the compressed gas may comprise oxygen and has a pressure greater than a pressure of the liquid media. In addition, the system may comprise sub-micron sized bubbles created on the wet side of the ceramic membrane when the compressed gas passes through the pores and expands in the liquid media. The bubbles are removable from the wet side of the ceramic membrane by the passing liquid media while the bubbles have buoyancy insufficient to overcome a surface tension between the ceramic membrane and the bubbles. The bubbles diffuse into the aqueous phase creating dissolved oxygen that is capable of oxidizing soluble oxidizable metals in the liquid media to create oxidized insoluble metal particles. Also, a system according to this embodiment may include a second filtration unit downstream from the cross-flow filtration unit and configured to filter the oxidized insoluble metal particles from the liquid media.

In yet another embodiment, a method of chemical-free removal of oxidizable metals from a contaminated liquid media is disclosed. The method may comprise receiving the liquid media in a dissolved oxygen addition device comprising a substrate having pores therethrough, and passing the liquid media along a wet side of the substrate. In such embodiments, the method may also include providing a compressed gas to the dissolved oxygen addition device, wherein the compressed gas comprises oxygen and has a pressure greater than a pressure of the contaminated liquid media. Such methods may further include injecting the compress gas through the substrate to the passing liquid media, and creating sub-micron sized bubbles on the wet side of the substrate via the injecting when the compressed gas passes through the pores and expands in the liquid media. Moreover, such a method may include scrubbing the bubbles from the wet side via the passing liquid media while the bubbles have buoyancy insufficient to overcome a surface tension between the substrate and the bubbles. Then, the method may include oxidizing soluble oxidizable metals in the liquid media with the bubbles to create oxidized insoluble metal particles.

### BRIEF DESCRIPTION OF THE DRAWINGS

Embodiments are illustrated herein by way of example in the accompanying figures, in which like reference numbers indicate similar parts, and in which:

FIG. 1 illustrates one embodiment of a decontamination system incorporating the disclosed aeration technology for the chemical-free removal of oxidizable metals from contaminated liquid media in accordance with the disclosed principles; and

FIG. 2 illustrates another embodiment of a decontamination system incorporating the disclosed aeration technology for the chemical-free removal of oxidizable metals from contaminated liquid media in accordance with the disclosed principles.

### DETAILED DESCRIPTION

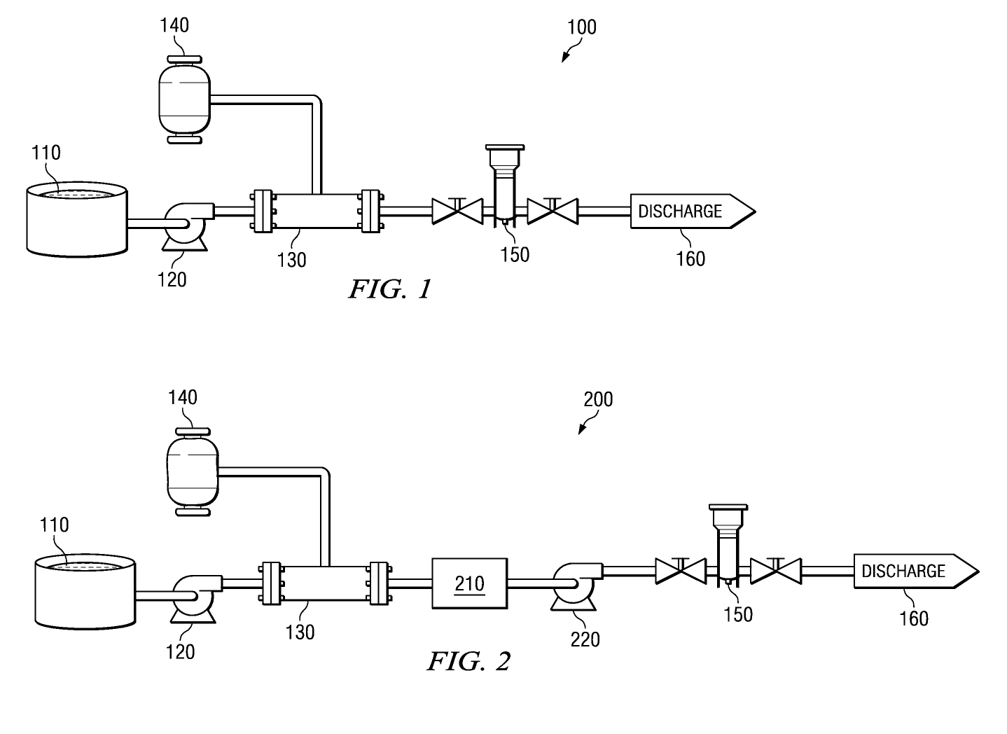

FIG. 1 illustrates one embodiment of a decontamination system 100 incorporating the disclosed aeration technology for the chemical-free removal of oxidizable metals, such as iron or manganese, from a liquid media contaminated with these metals. The system 100 includes a source of contaminated media 110, which in this type of system 100 is typically a fluid such as contaminated water 110. Of course, other types of contaminated media may also be employed by the system 100. The contaminated fluid 110 may be retrieved from a storage tank or reservoir, or from any other available source.

The contaminated fluid 110 is transferred, for example, via a pump 120, to a dissolved oxygen (DO) addition device 130. In advantageous embodiments, the DO addition device 130 includes substrate, such as a ceramic membrane typical of what is commonly used in cross-flow filtration units. The advantages of a ceramic substrate are the durability of such materials. However, as described in greater detail below, the ceramic substrate in the DO addition device 130 is not used in accordance with the disclosed principles to filter out contaminants. In disclosed systems 100, the DO addition device 130 generates micro-bubbles in order to increase or maximize its surface area, which enhances the ability to diffuse into the aqueous phase. This creates dissolved oxygen in the contaminated media, for a given volume of gas, and readily oxidizes soluble oxidizable metals into insoluble metal oxides.

The system 100 includes an aeration source 140, connected to DO addition device 130. In the illustrated embodiment, the aeration source 140 comprises compressed gas containing oxygen, and may specifically comprise compressed air or oxygen. The compressed gas source 140 is connected to the DO addition device 130 to provide the compressed gas therein. In exemplary embodiments where a cross-flow filtration device is employed, the compressed gas source 140 is connected to the permeate side (the dry side) of the DO addition device 130. As discussed above, one technique for removing ferrous iron and other similar oxidizable metals from a contaminated media is to oxidize the ferrous iron into insoluble ferric oxide. The gas flow may or may not be controlled by valves or mass flow controllers or other control devices. The compressed gas, which in accordance with the disclosed principles has a pressure greater than the pressure of the wastewater, is pushed through the DO addition device 130. With the increased pressure of the compressed gas causing it to flow through the DO addition device 130, and more specifically through the substrate in the device 130, bubbles are created in the liquid media 110 passing against the substrate and through the DO addition device 130.

More specifically, the bubbles are generated by passing the compress gas across or through tiny holes or pores in the substrate in the DO addition device 130 to generate the bubbles on the side of the substrate where the liquid media 110 passes. The generated micro-bubbles or sub-micron in size bubbles are thus small enough so that their buoyancy does not allow the bubbles to overcome the surface tension of the substrate. As such, the bubbles do not detach from the substrate and rise to the top of the contaminated fluid 110. In conventional air-scrubbing filtration systems, large bubbles in a contaminated fluid have an increased buoyancy, and thus detach from the substrate on which they are created and then float to the top of the contaminated liquid media. This rising of the conventional bubbles provides for the air stripping of organic contaminants if present in the contaminated fluid. In contrast, since the bubbles generated in accordance with the disclosed principles have a decreased buoyancy, they do not detach from the wet side of the substrate and rise to the top of the contaminated fluid; thus, no air scrubbing of VOCs or other contaminants is provided. Instead, in accordance with the disclosed principles, only the scrubbing of the passing liquid media 110 along the wet side of the substrate in the DO addition device 130 causes the bubbles to be released into the liquid media 110.

With the creation of bubbles, the amount of oxygen within the DO addition device 130 is substantially increased due to the increased surface area provided by the tiny bubbles. Employing the disclosed principles, therefore, maximizes the surface area-to-volume ratio of the air or oxygen gas used in the system 100. Stated another way, using the same volume of gas, the creation of a greater number of bubbles instead of a lesser number of larger bubbles increases the surface area of oxygen in the liquid media. This in turn maximizes the contact between the oxygen in the gas and the liquid media, while minimizing the volume of gas needed. In exemplary embodiments, a ratio of about 76 l/min of contaminated media per 30 l/min of pressurized air may be achieved. In other embodiments, if pure pressurized oxygen is used, a ratio of about 76 l/min of contaminated media per nominally 6 l/min of pressurized oxygen may be achieved. Of course, in accordance with the disclosed principles, any type of filter unit may be used as the DO addition device 130, so long as it is capable of creating bubbles, as defined herein, to be formed inside of it to oxidize the oxidizable metal particles in the passing liquid media 110.

In addition, the increased pressure of the compressed gas, as well as the gas being forced through the pores of the substrate(s) being scrubbed by the passing fluid, produces a high-turbulent mixing action within the DO addition device 130. For example, a high Reynolds numbers in the turbulent range has shown to be effective in the disclosed technique. Such a high Reynolds number may be achieved using a contaminated media flow rate of about 4 l/min through a 4 mm channel and releasing it into the permeate side of a cross-flow filtration unit employing ceramic membranes with openings less than 1 micron in diameter. The net effect of the maximized surface area-to-volume ratio of the gas, along with the high-turbulent mixing provided by the release of a pressurize gas through the substrate, is that the liquid media 110 will become saturated with dissolved oxygen with significantly less volumes of gas having to be employed. Moreover, because the buoyancy of the bubbles keeps them from detaching from the substrate and rising in the fluid 110, and are only removed by the passing liquid media 110 scrubbing the wet side of the substrate, the oxygen provided by the bubbles is more evenly diffused throughout the liquid media 110, which increases the efficiency of the disclosed oxidizing process.

With this novel aeration technique, all that is left in the liquid media 110 once it exits the DO addition device 130 is insoluble metal particles, such as ferric or iron oxide (Fe₂O₃). Such insoluble metal particles tend to floc as relatively large particles. These insoluble particles may then settle to the bottom of a settling tank, or be removed from the system 100 using almost any type of simple filtration system. The disclosed oxidation technique may be done prior to or in conjunction with the filtering out of organic contaminants in the liquid media 110. Moreover, the disclosed technique provides this beneficial transfer of metals from soluble to insoluble form generally without air stripping VOCs or other contaminants from the contaminated fluid.

As mentioned above, once the metal particles have been converted to insoluble particles, the insoluble metal particles may then be removed via simple filtration techniques. In the illustrated embodiment, the system 100 further includes a filter unit 150 downstream from the DO addition device 130, and which is used to filter out, for example, the ferric oxide. Once the filter unit 150 removes the ferric oxide, the remaining media may then be discharged 160 from the system 100. Moreover, the disclosed approach is a desirable method of removing the insoluble metal from a contaminated media 110 because no aggressive chemicals are required. Therefore, in many applications, the insoluble oxidized metal, such as ferric oxide, can be discharged 160 to the sanitary sewer system, eliminating off-site disposal and thereby reducing overall system costs.

In advantageous embodiments, a backwashable filter unit 150 may be used to filter out the oxidized insoluble metal particles. Typically, a backwashable-type filter, such as a sand filter, may be used to filter out the oxidized insoluble metal particles. In such embodiments, before regenerating the filter bed of the DO addition device 130, the bed is purged with treated water in order to remove VOCs and other dissolved contaminants from the DO addition device 130. In this manner, during a backwash event for the backwashable filter 150, the only constituent removed by the backwash process is the oxidized insoluble metal particles. The backwash itself will be free of the VOC contaminants. Thus, as before, assuming no other VOC and other contaminants are present in it, the filtered oxidized iron or other metal can either be discharged, for example, down the sanitary sewer, or alternatively collected and decanted.

FIG. 2 illustrates another embodiment of a decontamination system 200 incorporating the disclosed aeration technology for the chemical-free removal of iron or other oxidizable metals from a liquid media in accordance with the disclosed principles. The system 200 again includes a source of contaminated media 110, e.g., contaminated with soluble iron or manganese or other oxidizable metal. Again the contaminated media 110 is typically a fluid such as contaminated water 110 retrieved from a storage tank or reservoir, or from any other available source, and transferred via a pump 120, to an DO addition device 130.

As discussed above, the aeration source 140 connected to DO addition device 130 can comprise compressed air or oxygen, and is metered into the permeate side of the DO addition device 130. The compressed gas again has a pressure greater than the pressure of the wastewater, and this is forced through one or more substrates or membranes in the DO addition device 130 so that bubbles are created on the wet side of the substrate where liquid media 110 is passed. Specifically, as the high-pressure oxygen-containing gas is passed through the pores of the membrane or substrate in the DO addition device 130, the rapidly expanding gas combined with the forceful passing of contaminated media 110 across openings in the substrate cause the formation of the bubbles on the wet side of the substrate. Again the bubbles contain oxygen and are sub-micron in size, and thus do not have enough buoyancy to overcome the surface tension of the membrane or substrate in the DO addition device 130, and therefore do not readily rise in the contaminated fluid. Instead, the bubbles are removed from the substrate by the scrubbing of the liquid fluid 110 passing against the wet side of the substrate holding the bubbles, which in turn causes the bubbles to diffuse throughout the passing liquid media 110.

In addition, in this embodiment of the disclosed principles, a settling or holding tank 210 is included downstream from the DO addition device 130. Liquid media that has flowed through the DO addition device 130, along with the bubbles created therein by the compressed gas, flow into the holding tank 210. In such embodiments, the holding tank 210 may be employed to allow additional time for the dissolved oxygen in the contaminated media 110 to oxidize the dissolved iron (or other oxidizable metals) into insoluble ferric oxide, in the manner discussed above. Such an embodiment may be particularly beneficial in high-flow decontamination systems, in order to provide sufficient time for the dissolved iron to be converted into insoluble ferric oxide. As such, the size or volume of the holding tank 210 may be varied depending on each particular application.

Once the oxidizable metal particles have been converted to oxidized insoluble metal particles, the oxidized insoluble metal particles may again be removed via simple filtration techniques. In the embodiment of FIG. 2, the system 200 further includes a second pump 220 to pump the media settling in the holding tank 210 to a filter unit 150 downstream from the DO addition device 130. Then, as before, the filter unit 150 is used to filter out the oxidized insoluble metal particles. Once the filter unit 150 removes the oxidized insoluble metal particles, e.g., the ferric oxide, the remaining media may then be discharged 160 from the system 200, and properly disposed of in accordance with safe environmental practices.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R.1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A system for chemical-free removal of oxidizable metals from a liquid media, the system comprising:
a dissolved oxygen addition device comprising a substrate having pores therethrough between a dry side and a wet side, the substrate configured to receive the liquid media along its wet side;
a compressed gas source connected to the dissolved oxygen addition device and configured to inject compressed gas through the substrate to the liquid media, wherein the compressed gas comprises oxygen and has a pressure greater than a pressure of the liquid media; and
sub-micron sized bubbles created on the wet side when the compressed gas passes through the pores and expands in the liquid media, wherein the bubbles are removable from the wet side by passing liquid media while having buoyancy insufficient to overcome a surface tension between the substrate and the bubbles, the bubbles diffusing into the liquid media to create dissolved oxygen that is capable of oxidizing soluble oxidizable metals in the liquid media to create oxidized insoluble metal particles.

2. A system according to claim 1, wherein the dissolved oxygen addition device comprises a cross-flow filtration unit, and wherein the substrate comprises a ceramic filter membrane having openings therethrough.

3. A system according to claim 2, wherein the compressed gas source is connected to the permeate side of the dissolved oxygen addition device.

4. A system according to claim 1, wherein the substrate has pores less than 1 micron in diameter, and wherein injecting the compressed gas through the dry side of the substrate and into liquid media scrubbing the set side of the substrate at a flow rate of 4 l/min achieves a Reynolds number in the turbulent range.

5. A system according to claim 1, wherein the system further comprises a settling tank downstream from the dissolved oxygen addition device, the settling tank configured to receive and temporarily hold liquid media and bubbles from the dissolved oxygen addition device.

6. A system according to claim 1, further comprising a filtration unit downstream from the dissolved oxygen addition device, the filtration unit configured to filter the oxidized insoluble metal particles from the liquid media.

7. A system according to claim 7, wherein the filtration unit comprises a backwashable-type filtration unit.

8. A system according to claim 1, wherein the oxidizable metals comprise iron or manganese.

9. A method of chemical-free removal of oxidizable metals from a liquid media, the method comprising:
receiving the liquid media in a dissolved oxygen addition device comprising a substrate having pores therethrough;
passing the liquid media along a wet side of the substrate;
providing a compressed gas to the dissolved oxygen addition device, wherein the compressed gas comprises oxygen and has a pressure greater than a pressure of the contaminated liquid media;
injecting the compress gas through the substrate to the passing liquid media;
creating sub-micron sized bubbles on the wet side of the substrate via the injecting when the compressed gas passes through the pores and expands in the liquid media;
scrubbing the bubbles from the wet side via the passing liquid media while the bubbles have buoyancy insufficient to overcome a surface tension between the substrate and the bubbles; and
oxidizing soluble oxidizable metals in the liquid media with the bubbles dissolved into the passing liquid media to create oxidized insoluble metal particles.

10. A method according to claim 9, wherein the dissolved oxygen addition device comprises a cross-flow filtration unit, and wherein the substrate comprises a ceramic filter membrane having openings therethrough.

11. A method according to claim 10, wherein providing a compressed gas comprises providing a gas to the permeate side of the dissolved oxygen addition device.

12. A method according to claim 9, wherein the injecting, creating and scrubbing achieves a Reynolds number in the turbulent range when the substrate has pores less than 1 micron in diameter and the liquid media scrubs the wet side of the substrate at a flow rate of about 4 l/min.

13. A method according to claim 9, further comprising temporarily holding the liquid media and bubbles from the dissolved oxygen addition device in a settling tank downstream from the dissolved oxygen addition device.

14. A method according to claim 9, further comprising filtering the insoluble oxidized metal particles from the liquid media.

15. A method according to claim 9, wherein the oxidizable metals comprise iron or manganese.

16. A system for chemical-free removal of oxidizable metals from a liquid media, the system comprising:
a cross-flow filtration unit configured to receive the liquid media therein;
a ceramic membrane having pores therethrough between a dry side and a wet side, the ceramic membrane configured to receive the liquid media along its wet side;
a compressed gas source connected to the dissolved oxygen addition device and configured to inject compressed gas through the ceramic membrane to the liquid media, wherein the compressed gas comprises oxygen and has a pressure greater than a pressure of the liquid media;
sub-micron sized bubbles created on the wet side when the compressed gas passes through the pores and expands in the liquid media, wherein the bubbles are removable from the wet side by passing liquid media while having buoyancy insufficient to overcome a surface tension between the ceramic membrane and the bubbles, the bubbles diffusing into the liquid media to create dissolved oxygen that is capable of oxidizing soluble oxidizable metals in the liquid media to create oxidized insoluble metal particles; and
a second filtration unit downstream from the cross-flow filtration unit and configured to filter the oxidized insoluble metal particles from the liquid media.

17. A system according to claim 16, wherein the ceramic membrane comprises a plurality of ceramic filtration elements, and wherein the compressed gas source is connected to the permeate side of the cross-flow filtration unit.

18. A system according to claim 16, wherein the ceramic membrane has pores less than 1 micron in diameter, and wherein injecting the compressed gas through the dry side of the ceramic membrane and into liquid media scrubbing the set side of the ceramic membrane at a flow rate of 4 l/min achieves a Reynolds number in the turbulent range.

19. A system according to claim 16, wherein the system further comprises a settling tank between the cross-flow filtration unit and the second filtration unit, the settling tank configured to receive and temporarily hold filtered liquid media and bubbles from the cross-flow filtration unit.

20. A system according to claim 16, wherein the oxidizable metals comprise iron or manganese.
